(19) United States
(12) Patent Application Publication
(10) Pub. No.: US 2015/0204197 A1
(43) Pub. Date: Jul. 23, 2015

(54) AIRFOIL LEADING EDGE CHAMBER COOLING WITH ANGLED IMPINGEMENT

(71) Applicant: Siemens Aktiengesellschaft, München (DE)

(72) Inventors: Ching-Pang Lee, Cincinnati, OH (US); Jae Y. Um, Winter Garden, FL (US); Gerald L. Hillier, Charlottesville, VA (US); Eric Schroeder, Loveland, OH (US); Erik Johnson, Cincinnati, OH (US)

(21) Appl. No.: 14/161,817

(22) Filed: Jan. 23, 2014

(51) Int. Cl. F01D 5/18; F01D 9/02

(52) U.S. Cl. CPC F01D 5/187; F01D 9/02; F05D 2260/201

(57) ABSTRACT

An airfoil cooling arrangement (12), including: a leading edge chamber (54) configured to cool an interior surface (68) of an airfoil; and an impingement orifice (60) configured to direct an impingement jet (64) toward an impingement location (66) disposed on the interior surface and offset from a camber line (28) of the airfoil The airfoil cooling arrangement is effective to guide post impingement cooling fluid along the interior surface, through a leading portion (76) of the leading edge chamber, and then back toward a trailing edge (22) of the airfoil in a helical motion (114). A stagnation region (104) is formed adjacent the interior surface and on a trailing edge side of the impingement location, and a relatively high static pressure associated therewith is effective to contribute to the helical motion (114) of the post impingement cooling fluid within the leading edge chamber

### FIELD OF THE INVENTION

The invention relates generally to cooling arrangements for airfoils, and more specifically in an embodiment to a cooling arrangement for a leading edge chamber of an airfoil that utilizes angled impingement to generate a helical flow of cooling fluid.

### BACKGROUND OF THE INVENTION

Gas turbine engines include a compressor to compress air, a combustor to receive the compressed air, mix it with fuel, and combust the mixture, and a turbine to receive the combustion products and transfer its energy into rotational energy. The turbine does this by placing turbine blades in the flow of combustion products and allowing them to be turned by the force of the combustion products Turbine blades disposed in the flow of the extremely hot combustion products are often kept cool by any or all of three methods providing convection cooling inside the blade through the use of internal cooling circuits; providing film cooling outside the blade through the use of film cooling holes between an internal cooling circuit and an exterior of the blade; and providing a thermal barrier coating. As operating temperatures increase the blade material is pushed closer to its limits, and this increases the need for proper cooling

Some gas turbine engines are configured to operate on crude oil and during this operation the film cooling holes can become clogged The leading edge of the blade is particularly susceptible to this This clogging restricts or completely blocks the film cooling, and this may, in turn, cause the blade to overheat during operation. Consequently, there remains room in the art for improvement.

### BRIEF DESCRIPTION OF THE DRAWINGS

The invention is explained in the following description in view of the drawings that show

FIG. 1 is a first cross sectional view of an airfoil with a leading chamber cooling arrangement disclosed herein.

FIG. 2 is a second cross sectional view of the airfoil of FIG. 1.

FIG. 3 is a schematic view of the flow of cooling fluid in the cooling circuits as viewed in FIG. 2.

FIG. 4 is a cross sectional view of a portion of a core used to cast the cooling arrangement of FIG. 1

FIG. 5 is a view along 5-5 of the core of FIG. 4

FIG. 6 is a view along 6-6 of the core of FIG. 4.

FIG. 7 is a close up of the core of FIG. 5

FIG. 8 is a view along 8-8 of the core of FIG. 7

FIG. 9 is a view along 9-9 of the airfoil of FIG. 1

FIG. 10 is a view along 10-10 of FIG. 2 of a flow of cooling fluid with the airfoil of FIG. 2.

### DETAILED DESCRIPTION OF THE INVENTION

The present inventors have recognized that the conventional practice of film cooling a turbine airfoil such as that of a blade or a vane can be incompatible with a gas turbine engine combusting crude oil Contrary to convention, which would typically provide more film cooling to overcome reduced effectiveness of the existing film cooling, the inventors have instead taken the unconventional approach that permits the reduction of or elimination of film cooling altogether This approach is made possible because the inventors have devised a highly efficient convection cooling arrangement where aspects work together so well that the film cooling is not absolutely necessary Reducing or eliminating the film cooling in this manner will be an option for some time to come despite the progressively increasing operating temperatures in which the airfoils will be asked to operate due to the substantial increase in cooling made possible by the inventive arrangement Specifically, the improved convection cooling arrangement increases the amount of heat transfer area and provides a better heat transfer coefficient for a given amount of cooling flow compared to the prior art convection cooling arrangements

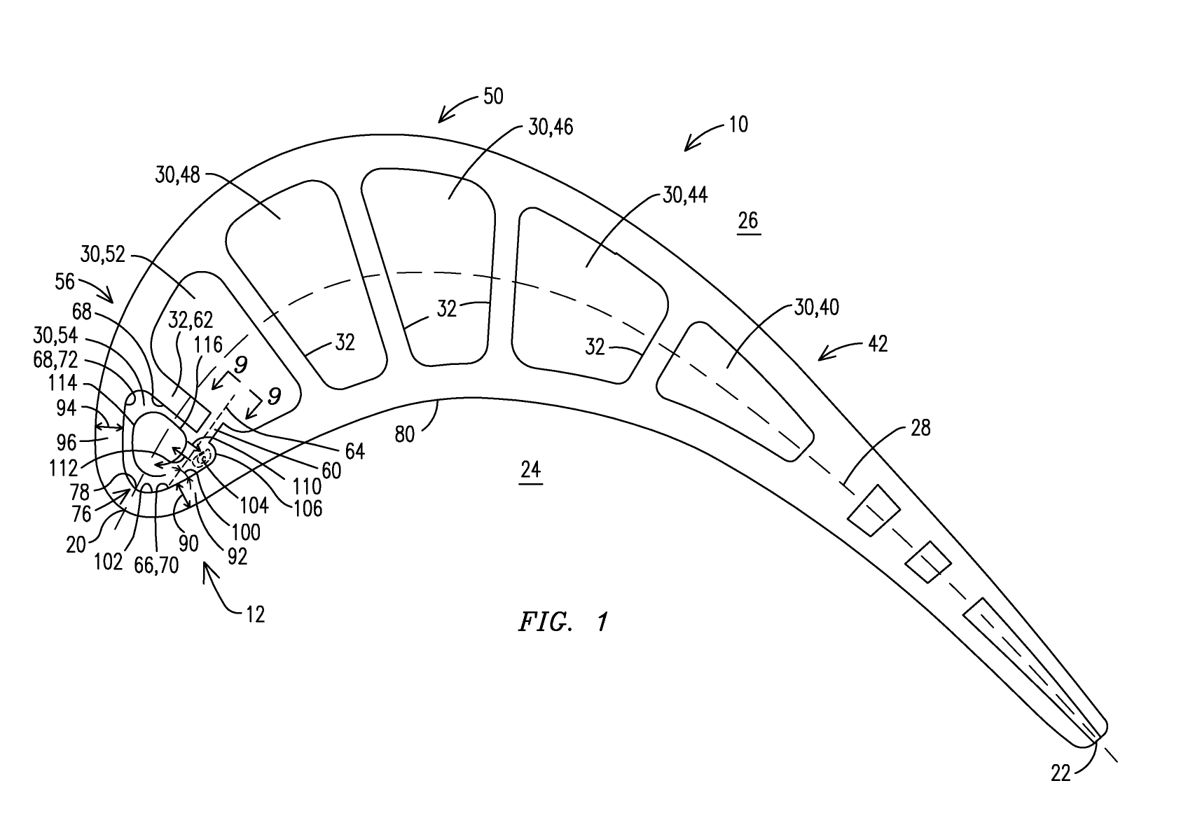

FIG. 1 is a first cross sectional view of an airfoil 10 with a leading chamber cooling arrangement 12. The airfoil 10 may be the type used for a turbine blade or vane and includes a leading edge 20, a trailing edge 22, a pressure side 24, a suction side 26, a mean camber line 28, internal chambers 30 separated by ribs 32 Chamber 40 forms part of a trailing edge circuit 42 Chambers 44, 46, and 48 form part of a middle circuit 50 Supply chamber 52 and leading chamber 54 form part of a leading edge circuit 56.

The leading chamber cooling arrangement 12 includes the supply chamber 52, the leading chamber 54, and impingement orifices 60 connecting the two chambers through a separating rib 62 Each impingement orifice is configured to form an impingement jet 64 and direct the impingement jet 64 toward an impingement location 66 The impingement location 66 is disposed on an interior surface 68 of the leading chamber 54 and offset from the mean camber line 28. The impingement location 66 can be on a pressure side interior surface 70 or a suction side interior surface 72 The pressure side 24 is typically hotter than the suction side 26 and for this reason may be a location of choice for certain exemplary embodiments

A leading portion 76 of the leading chamber 54 is a portion that includes a fore-most point 78 of the interior surface 68 with respect to the mean camber line 28. The impingement location 66 is disposed offset from fore-most point 78 The fore-most point 78 and the mean camber line 28 may align, but they also may not align. If a contour of the interior surface 68 of the leading chamber 54 exactly matches a contour of an outer surface 80 of the airfoil 10, then the mean camber line 28 may align with the fore-most point 78 Whether they align exactly will also depend on a thickness 90 of a pressure side wall 92 and a thickness 94 of a suction side wall 96, and a positioning of the leading chamber 54 within the airfoil 10 etc If the contour of the leading chamber 54 does not exactly match the contour of the outer surface 80 of the airfoil 10 then the mean camber line 28 may not align with the fore-most point 78.

Unlike any prior art known to the inventors, the impingement location 66 is not disposed on the fore-most point 78. Instead, the impingement location 66 is disposed aft of the fore-most point 78. When the impingement location 66 is disposed on the fore-most point 78 cooling fluid from the cooling jet spreads out on both sides of the impingement location Some of the cooling fluid flows along the pressure side interior surface 70, while some of the cooling fluid flows along the suction side interior surface 72. The impingement jet is essentially split in those embodiments In other embodiments there is no impingement, but instead there is more of a shear action where the jet is guided parallel to the surface being cooled.

In contrast, in the exemplary embodiment shown the impingement location 66 is disposed aft of the fore-most point 78. The impingement jet 64 flows forward from an impingement orifice 60 located aft of the impingement location 66, and the impingement jet 64 forms an impingement angle 100 less than ninety degrees with the surface being impinged 102, which is the pressure side interior surface 70 in this exemplary embodiment In this configuration the cooling fluid of the impingement jet 64 impacts the surface being impinged 102 and flows forward toward the fore-most point 78 of the leading chamber 54 Thus, instead of the impingement jet 64 splitting as in the prior art, most of the cooling fluid will continue forward after impinging the interior surface 68, flow across the fore-most point 78, and then begin to flow aft-ward toward the training edge 22 along an opposing interior surface which is, in this case, the suction side interior surface 72

Another acceptable exemplary embodiment would be essentially a mirror image of that shown in FIG. 1, where the impingement location 66 is disposed on the suction side interior surface 72 and after impinging the suction side interior surface 72 the cooling fluid flows forward and rounds the fore-most point 78 before flowing aft toward the trailing edge 22 along the opposite-sided pressure side interior surface 70 The impingement orifices 60 may be located on a same side of the mean camber line 28 as the impingement location 66. Alternately, the impingement orifices 60 may be located anywhere so long as a respective impingement jet impinges the interior surface 68, rounds the fore-most point 78, and then flows aft.

The unique arrangement shown also forms a stagnation region 104 in a corner 106 between the separating rib 62 and the pressure side interior surface 70, and spanning a portion of a length of the airfoil 10 from a base (not shown) to a tip (not shown) where the impingement orifices 60 are present. This stagnation region 104 exhibits a relatively high static pressure After flowing toward the trailing edge 22 the cooling fluid encounters the separating rib 62 and at this point it turns to flow toward the impingement orifices 60 Typically, when the cooling fluid reaches the impingement jets 64 the post-impingement cooling fluid would try to flow across and between the impingement jets 64. This action is known as a cross flow and is often undesirable as it interferes with the impingement jets 64 However, the relatively high static pressure associated with the stagnation region 104 slows the post impingement cooling fluid that is approaching the impingement orifices 60 This slowing essentially works against motion of the cooling fluid in a radially outward direction 110 and instead it urges the cooling fluid in a radially inward direction 112. The momentum of the cooling fluid, the geometry of the leading chamber 54, and the radially inward urging cooperate such that the cooling fluid does not travel across the impingement jets 64 and into the corner 106, but instead is redirected so that it flows circularly as viewed in FIG. 1 The circular motion together with the buildup of cooling fluid along the length of the airfoil 10 may create a tightening circular motion depending on a geometry of the leading chamber 54. This may occur because the spent cooling fluid is restricted from traveling radially outward by the impingement jets 64, yet more and more cooling fluid enters the leading chamber 54 along the length of the airfoil The only place for the spent cooling fluid to go is radially inward (toward the center of the leading chamber 54 in this view) and towards the exhaust. Cross flow in another direction, (out of the page) is also prevented by keeping the post impingement cooling fluid in the center of the leading chamber 54.

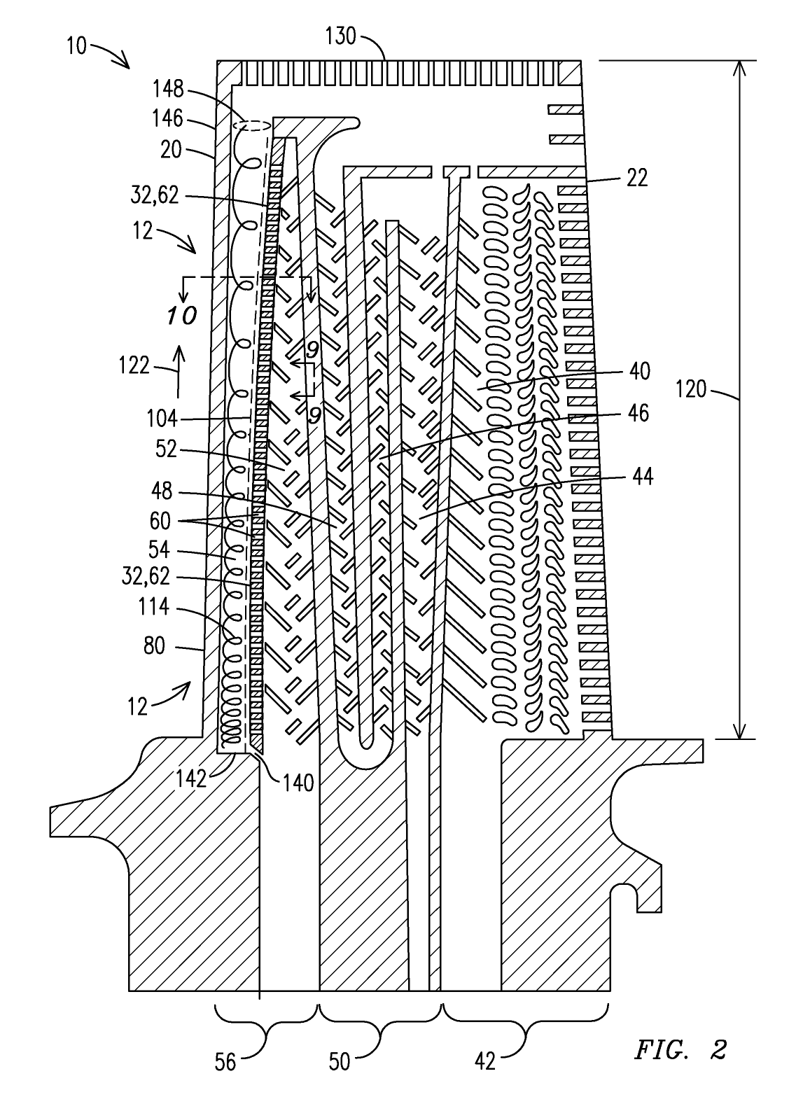

As can be seen in FIG. 2, which is a side cross sectional view of the airfoil 10 of FIG. 1, during the time the cooling fluid is moving circularly (as viewed in FIG. 1) it is also traveling along the length 120 of the airfoil 10 The circular motion together with the axial motion 122 along the length 120 of the airfoil 10 creates a helical motion 114. The stagnation region 104 prevents the helical motion 114 from expanding in diameter (i e from expanding outward as viewed in FIG. 1) into the impingement jets 64 as it flows along the length 120 of the airfoil 10. Without being bound to any particular theory, it is believed that without the resistance of the stagnation region the helical motion 114 could expand into the impingement jets 64 and create the unwanted cross flow that could begin to interfere with the impingement jets 64. The circular motion together with the axial motion along the length 120 of the airfoil 10 together with the radially inward motion may also create a tightening helical motion 116 that occurs when the stagnation region 104 urges the spent impingement fluid circularly and radially inward in certain configurations of the leading chamber 54 In addition to the above, the speed of the cooling fluid along the length will increase as the cooling fluid approaches the tip 130 of the airfoil because the amount of cooling fluid entering the leading chamber 54 increases progressively Thus, when viewed from the side, the helical motion 114 will lengthen/expand toward the tip 130.

The impingement action increases a heat transfer rate resulting in more efficient heat transfer from the outer surface 80 of the airfoil 10 The action of the spent impingement jet fluids working together to form a film of cooling fluid that flows across the interior surface 68 while rounding the fore-most point 78 and then traveling aft creates an amount of cooling fluid flow that facilitates even more heat transfer to the cooling fluid. In addition, since the cooling fluid is still relatively cool, and hence relatively dense immediately after impinging the interior surface 68 when compared to other cooling fluid in the leading chamber 54, the rotational motion is effective to keep the denser, cooler air against the very surface that needs the most cooling Further, as the cooling fluid grows warmer while it approaches the tip 130 it also accumulates more cooling fluid flow and accelerates Consequently, even though the cooling fluid is warming, the speed of the cooling fluid also increases, and so the increased speed mitigates a loss of cooling efficiency that might otherwise be associated with the warming of the cooling fluid.

The leading chamber cooling arrangement 12 may further include an optional initiation orifice 140 positioned at a root 142 of the leading chamber 54 and oriented in such a way that it will help facilitate helical motion 114. Specifically, the initiation orifice 140 forms an initiation jet (not shown) that will flow into the leading chamber 54 and initiation the helical motion 114 Cooling fluid entering the leading chamber 54 will join and contribute to the helical flow Located at a tip end 146 of the leading chamber 54 is an exhaust pathway 148. In the exemplary embodiment shown, all of the cooling fluid flowing into the leading chamber 54 ultimately flows out of the leading chamber 54 through the exhaust pathway 148. The location of the exhaust pathway 148 at the tip end 146 permits the movement of the cooling fluid along the length 120 of the airfoil 10, and so the exhaust pathway 148 and the impingement orifices 60 work together to create the helical motion 114, while the stagnation region 104 resists outward motion of the cooling fluid and instead contributes to circular/helical motion of the cooling fluid

FIG. 3 is a schematic view of the flow of cooling fluid in the cooling circuits 42, 50, 56 and tip circuit 160 as viewed in FIG. 2 In the trailing edge circuit 42 cooling fluid enters the chamber 40 and flows toward the tip 130 while along the length 120 of the airfoil 10 cooling fluid turns and flows out of the trailing edge 22 via a plurality of trailing edge orifices. In the middle circuit cooling fluid enters the chamber 44 and flows toward the tip 130, flows forward and then toward the base 162 of the airfoil 10. Upon reaching the base 162 the cooling fluid again flows forward and then toward the tip 130, where it exhausts into the tip circuit 160. In the leading edge circuit 56 the cooling fluid enters the supply chamber 52 and flows toward the tip 130 In the exemplary embodiment shown all of the cooling fluid in the supply chamber 52 flows into the leading chamber 54 through the impingement orifices 60. In another exemplary embodiment some of the cooling fluid in the supply chamber 52 could flow into the tip circuit 160 Upon entering the leading chamber 54 the cooling fluid flows as detailed above While the impingement orifices 60 may be oriented perpendicular to the axial motion 122 of the cooling fluid, the impingement orifices 60 may also be angled For example, angled orifice 164 may be oriented at a first angle 166 and angled orifice 168 may be oriented at a second angle 170, which may be the same or different than the first angle 166. Any combination of angles is possible. As can be seen in this exemplary embodiment all of the cooling fluid in the leading chamber 54 flows into the tip circuit 160. However, other circuit arrangements can be envisioned without departing from the spirit of the leading chamber cooling arrangement 12.

In an exemplary embodiment grooves may be disposed on the interior surface 68, on either or both of the pressure side interior surface 70 and the suction side interior surface 72 FIG. 4 is a cross sectional view of a portion of a core 180 that may be used to form the leading chamber cooling arrangement 12 of FIG. 1 Groove features 182 disposed on a core surface 184 form the grooves. The impingement location 66 may be upstream of an entry of the grooves, or may be located in or partially within a groove The grooves are arranged so that they cooperate with the helical motion of the cooling fluid within the leading chamber 54 Three may be one groove associated with each impingement location 66, plural grooves associated with each impingement location 66, or several impingement locations 66 associated with one groove

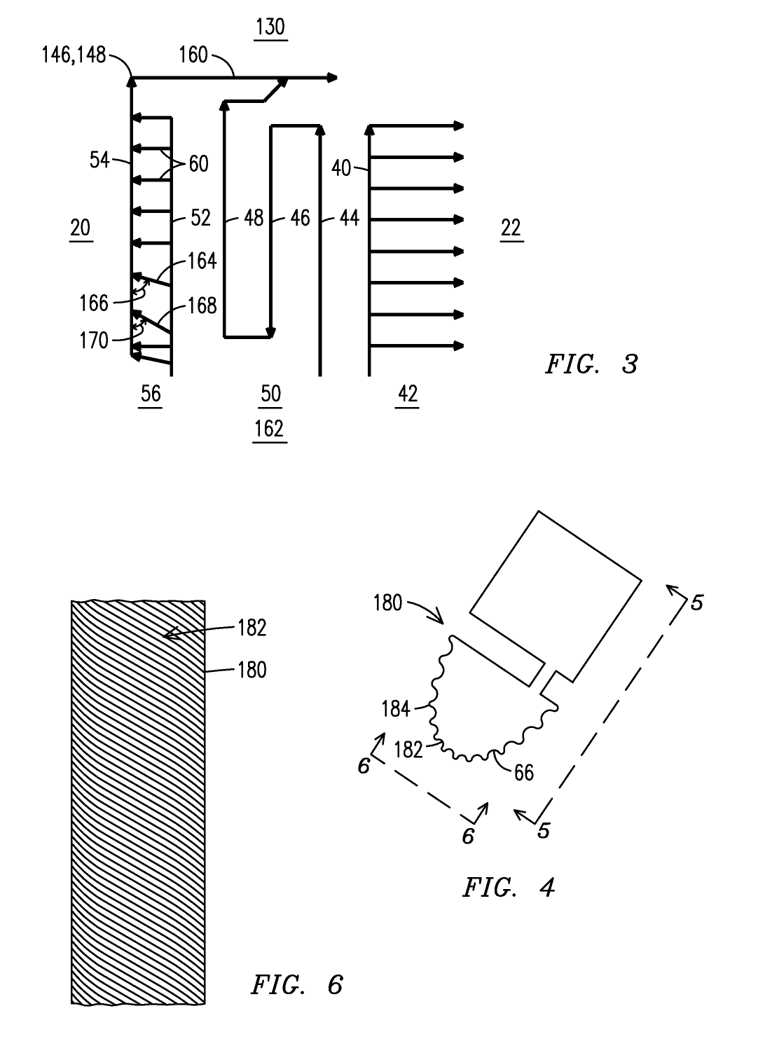

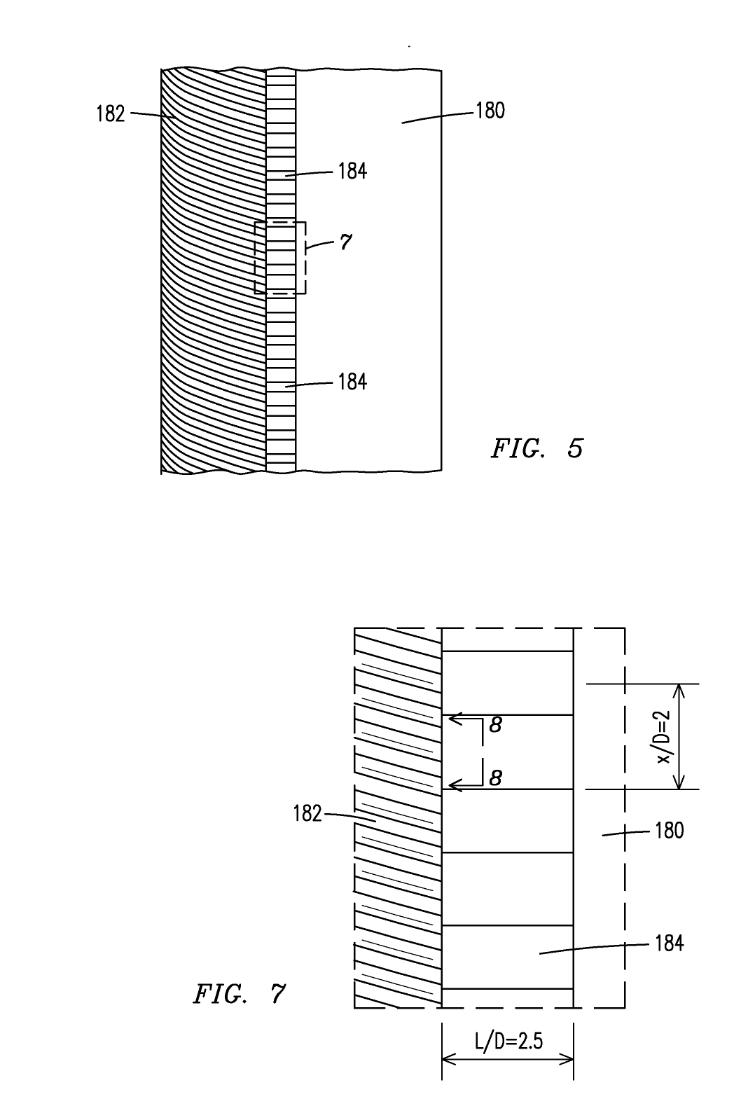

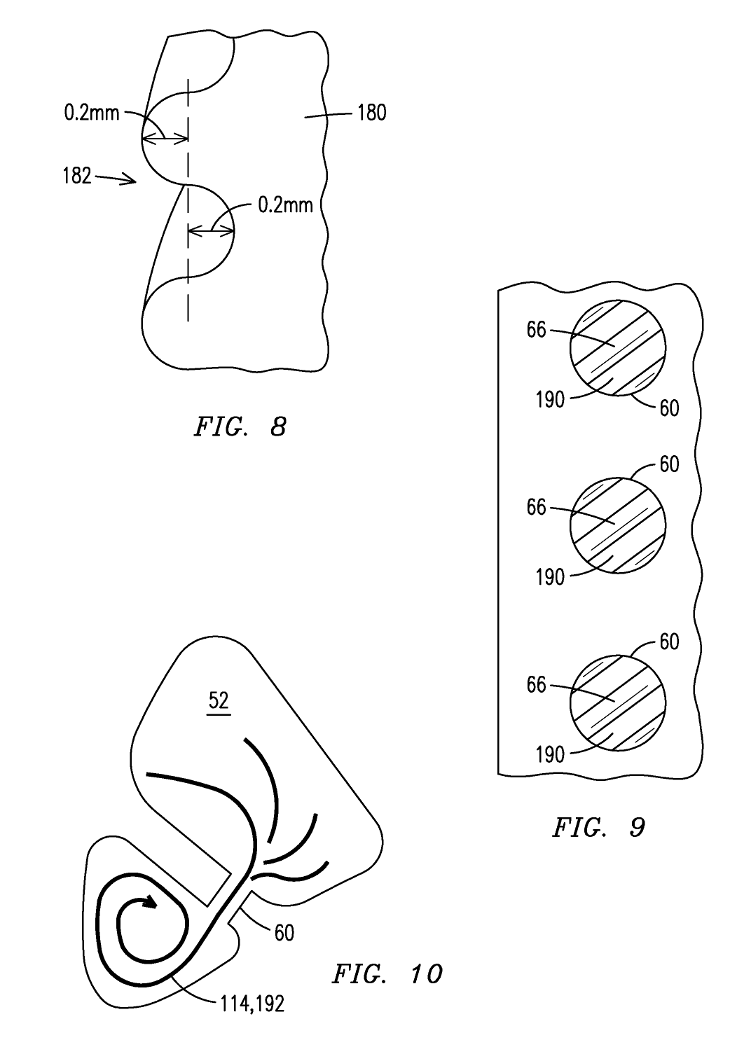

FIG. 5 is a view along 5-5 of the core 180 of FIG. 4 showing the groove features 182 It can be seen how the grooves formed by the groove features 182 would cooperate with the helical motion 114 of the cooling fluid by being formed to cross the leading portion 76 while being oriented from the root 142 to the exhaust pathway 148 of the airfoil 10 Also visible are impingement orifice features 184 that form the impingement orifices 60. FIG. 6 is a view along 6-6 of the core 180 of FIG. 4 and showing the groove features 182. FIG. 7 is a close up of the core 180 of FIG. 5 showing dimensions for an exemplary embodiment of the impingement orifice features 184 FIG. 8 is a view along 8-8 of the core 180 of FIG. 7 showing dimensions for an exemplary embodiment of the groove features 182

FIG. 9 is a view along 9-9 of the airfoil of FIG. 1 from the supply chamber 52 Visible through the impingement orifices 60 are the grooves 190 formed by the groove features 182. In this view the impingement locations 66 line up with their respective impingement orifice 60 and are disposed over grooves 190. The grooves 190 increase the surface area being cooled and this also contributes to an increase in cooling efficiency and may be present for some of all of the length 120 of the airfoil. The grooves 190 may be smooth along their entire length. For example, the length of the groove may be devoid of turbulators such as trip strips etc. in order to provide maximum aerodynamically smooth flow of the cooling fluid, optionally in the form of a film of cooling fluid, along the interior surface 68 The grooves 190 also help to keep the relatively cooler cooling fluid from mixing with the warmer cooling fluid for a longer time Thus, the arrangement works together to guide the warming cooling fluid toward the center of the leading chamber 54, further increasing the cooling efficiency. Further, the rotational movement keeps the coldest, most dense cooling fluid in a deepest portion of the groove where the airfoil wall is the thinnest The aspect of pressing the coolest cooling fluid against the thinnest part of the wall to be cooled also contributes to the increased cooling efficiency of the leading chamber cooling arrangement 12

FIG. 10 is a view along 10-10 of FIG. 2 of a flow of cooling fluid with the airfoil 10. Streamline 192 shows an example path cooling fluid may take in the exemplary embodiment of FIG. 2 The streamline 192 follows a helical motion 114 and simultaneously tightens its radius as it flows upward (out of the page) toward the tip 130 of the airfoil 10 to generate to cooling effect disclosed herein.

The exemplary embodiment shown and described above is devoid of film cooling holes altogether However, in an alternate exemplary embodiment as many or as few film cooling holes as desired may be incorporated into the leading chamber cooling arrangement 12. Incorporated film cooling holes could be disposed in a manner consistent with convention. For example, the film cooling holes could be disposed through the suction side wall 96 and configured to form a cooling film that protects the suction side wall 96 aft (toward the trailing edge 22) of the film cooling holes In one exemplary embodiment the arrangement could be configured so that sufficient cooling is provided even if the film cooling holes become clogged during operation, which is possible because the leading chamber cooling arrangement 12 is so effective. In this exemplary embodiment the film cooling holes may be configured to provide cooling above a design minimum under ideal (no clogs) operating conditions. This will accommodate reduced cooling associated with any subsequently formed clogs while still providing at least the design minimum cooling. Such a configuration could be implemented if there is an abundant supply of cooling fluid at hand Alternately, in a circumstance where cooling fluid is to be conserved, the leading chamber cooling arrangement 12 could be configured to include film cooling holes as integral to the design needed to reach the design minimum cooling In this scenario the amount of cooling fluid required is relatively lower and this, in turn, permits use of the cooling fluid elsewhere In many gas turbine engines the cooling fluid is compressed air and any compressed air not used to cool can be used in the combustion process This, in turn, increases the efficiency of the engine

From the foregoing it can be understood that the inventors have devised a unique cooling arrangement that is effective enough to dispense with the previously-required film cooling. Consequently, this represents an improvement in the art

While various embodiments of the present invention have been shown and described herein, it will be obvious that such embodiments are provided by way of example only. Numerous variations, changes and substitutions may be made without departing from the invention herein Accordingly, it is intended that the invention be limited only by the spirit and scope of the appended claims

The invention claimed is:

1. An airfoil cooling arrangement, comprising
a leading edge chamber configured to cool an interior surface of an airfoil directly adjacent a leading edge of the airfoil; and an impingement orifice configured to direct an impingement jet toward an impingement location disposed on the interior surface and offset from a camber line of the airfoil; and
wherein the airfoil cooling arrangement is effective to guide post impingement cooling fluid along the interior surface from the impingement location, through a leading portion of the leading edge chamber, and then back toward a trailing edge of the airfoil in a helical motion while also moving the post impingement cooling fluid toward a tip of the airfoil, and
wherein a stagnation region is formed adjacent the interior surface and on a trailing edge side of the impingement location, and a relatively high static pressure associated therewith is effective to contribute to the helical motion of the post impingement cooling fluid within the leading edge chamber.

2. The airfoil cooling arrangement of claim 1, further comprising an initiation orifice located at a root of the leading edge chamber and configured to form an initiation jet that contributes to the helical motion.

3. The airfoil cooling arrangement of claim 1, wherein the impingement location is disposed on a pressure side of the camber line.

4. The airfoil cooling arrangement of claim 1, wherein the airfoil comprises an airfoil of a blade, and the airfoil further comprises a blade tip cooling circuit that receives all of the post impingement cooling fluid from the leading edge chamber.

5. The airfoil cooling arrangement of claim 4, wherein the impingement orifice is angled toward the tip of the airfoil to contribute to the helical motion.

6. The airfoil cooling arrangement of claim 1, further comprising a plurality of impingement orifices arranged from a base to the tip of the airfoil and configured to direct a plurality of impingement jets into a plurality of grooves arranged from the base to the tip of the airfoil, the plurality of grooves configured to receive the plurality of impingement jets and cooperate with the helical motion.

7. The airfoil cooling arrangement of claim 6, wherein each of the plurality of grooves is configured to produce smooth flow within the respective groove along an entire length of the respective groove

8. The airfoil cooling arrangement of claim 6, wherein the post impingement cooling fluid from the plurality of impingement jets forms a film that flows helically with and immediately adjacent the plurality of grooves

9. The airfoil cooling arrangement of claim 6, wherein after flowing toward the trailing edge the post impingement cooling fluid flows toward both the plurality of impingement jets and the stagnation region whereupon the stagnation region is effective to reduce cross flow between the post impingement cooling fluid and the impingement jets.

10. An airfoil cooling arrangement, comprising:
a leading edge chamber defined by an interior surface of a pressure side of an airfoil, an interior surface of a suction side of the airfoil, and a surface of a rib spanning between the pressure side and the suction side;
a plurality of impingement orifices disposed along a length of and through the rib, the impingement orifices configured to direct a respective impingement jet onto an impinged surface of the leading edge chamber so that it will flow toward and then over a foremost point of the leading chamber; and
an exhaust pathway proximate a tip of the airfoil;
wherein the plurality of impingement orifices and the exhaust pathway are configured to work together to generate
a helical motion toward the exhaust pathway of cooling fluid within the leading edge chamber; and
a stagnation region in a corner between the impinged surface and the surface of the rib, the stagnation region effective to resist motion of the cooling fluid into the corner as it flows past the stagnation region.

11. The airfoil cooling arrangement of claim 10, further comprising an initiation orifice located at a root of the leading edge chamber and configured to form an initiation jet that cooperates with the helical motion.

12. The airfoil cooling arrangement of claim 10, wherein the impingement jets are disposed between the stagnation region and the helically moving cooling fluid and the stagnation region is effective to reduce cross-flow between the helically moving cooling fluid and the impingement jets

13. The airfoil cooling arrangement of claim 10, further comprising a plurality of grooves disposed in the impinged surface and oriented helically to cooperate with the helical motion of the cooling fluid.

14. The airfoil cooling arrangement of claim 13, wherein each of the plurality of grooves is configured to produce smooth flow within the respective groove along an entire length of the respective groove

15. The airfoil cooling arrangement of claim 10, wherein the leading edge chamber is disposed in an airfoil of a blade, wherein the exhaust pathway is configured to receive an entirety of cooling fluid flowing in the leading edge chamber.

16. The airfoil cooling arrangement of claim 10, wherein the impinged surface is the interior surface of the pressure side.

17. In an airfoil cooling arrangement for an airfoil comprising a pressure side, a suction side, a leading edge, a trailing edge, a leading edge chamber comprising a leading portion, a rib, and a plurality of impingement orifices through the rib, wherein the leading edge chamber is configured to exhaust cooling fluid therein through an exhaust pathway proximate a tip of the airfoil, an improvement comprising
impingement orifices that are oriented so cooling fluid impingement jets from the respective impingement orifices impinge a surface of the leading edge chamber on a same side of a camber line of the airfoil, travel along the surface toward and around the leading portion, and then toward a trailing edge of the airfoil in a helical motion; and
wherein the impingement orifices are oriented in a manner that creates a stagnant region of cooling fluid disposed in a corner of the leading edge chamber between the rib and the surface being impinged, the stagnation region effective to reduce cross flow between the helically moving cooling fluid and the impingement jets.

18. The airfoil cooling arrangement of claim 17, wherein the impingement jets are disposed between the helically moving cooling fluid and the stagnant region

19. The airfoil cooling arrangement of claim 17, further comprising a plurality of grooves disposed in the surface being impinged and oriented helically to cooperate with the helical motion of the cooling fluid

20. The airfoil cooling arrangement of claim 17, wherein the surface being impinged comprises the pressure side of the airfoil.
